(19) United States
(12) Patent Application Publication
(10) Pub. No.: US 2026/0286852 A1
(43) Pub. Date: Sep. 24, 2026

(54) BALANCING DEVICE FOR A ROTOR

(71) Applicant: Rolls-Royce Deutschland Ltd & Co KG, Blankenfelde-Mahlow (DE)

(72) Inventor: Steffen DREVS, Blankenfelde-Mahlow (DE)

(21) Appl. No.: 19/569,640

(22) Filed: Mar. 17, 2026

(30) Foreign Application Priority Data
Mar. 18, 2025 (DE) 10 2025 110 482.4

(51) Int. Cl. F01D 5/26

(52) U.S. Cl. CPC F01D 5/26; F05D 2260/96

(57) ABSTRACT

A balancing device for a rotor, includes: a receiving body that is arranged concentrically with an axis of rotation of the rotor and has a plurality of receiving openings distributed about the axis of rotation, and at least one balancing body, which is designed to be received in one of the receiving openings. A provision is made for the receiving openings to have an opening portion on a radially inner side, via which the balancing body can be inserted, and a limiting portion on a radially outer side, wherein the balancing body bears on the limiting portion when in the inserted state, and for the balancing device to have a securing ring, which is arranged radially inside the receiving body and is designed to be brought into contact with the at least one balancing body and to retain the balancing body in the receiving opening.

### CROSS REFERENCE TO RELATED APPLICATIONS

This application claims priority to German Patent Application 102025 110 482.4 filed Mar. 18, 2025, the entirety of which is incorporated by reference herein.

### BACKGROUND

The disclosure relates to a balancing device for a rotor. Balancing devices for rotors, in particular in engines or work machines, are well known.

Balancing devices ensure true running for rotating devices, in particular machines, by compensating specifically imbalances that arise for example as a result of assembly and/or manufacturing tolerances. In this regard, the balancing device can cause in particular specifically changes in mass, for example through the addition or removal of weight at particular positions of the rotor. In general, for balancing devices, it is important that they be attached securely during operation, i.e. that the balancing device and/or individual balancing bodies of the balancing device do not move out of their receptacle in an uncontrolled manner. Furthermore, it is desirable to keep assembly effort and balancing effort as low as possible.

Balancing devices of the generic type are shown, for example, in US 2020/056482 A1 or US 11732585 B2.

Balancing devices are worthy of further improvement with regard to one or more of the abovementioned aspects.

This is where the present disclosure comes in. In a first aspect, the disclosure proposes a balancing device. The disclosure proceeds from a balancing device for a rotor, comprising a receiving body that is arranged concentrically with an axis of rotation of the rotor and has a plurality of receiving openings distributed about the axis of rotation, and at least one balancing body that is designed to be received in one of the receiving openings.

According to the disclosure, provision is made for the receiving openings to have an opening portion on a radially inner side, via which the balancing body can be inserted, and a limiting portion on a radially outer side, wherein the balancing body bears on the limiting portion when in the inserted state, and the balancing device has a securing ring which is arranged radially inside the receiving body and is designed to be brought into contact with the at least one balancing body and to retain the balancing body in the receiving opening.

The disclosure is based on the finding that, firstly, secure retention of the balancing body is to be ensured but, secondly, simple assembly and a design of the balancing device that saves installation space and weight are also advantageous. Since the receiving body of the balancing device has the receiving openings on its radially inner side, via the opening portion of which the balancing bodies can be inserted, good accessibility, in particular for assembly, is made possible. Such accessibility is advantageous in particular when the installation space is highly utilized and components which are closely adjacent, in particular axially, make accessibility more difficult. By means of the limiting portions of the receiving openings, which are arranged on the radially outer side of the receiving body, secure retention of the balancing bodies is additionally ensured, which prevents detachment or slipping even at high rotational speeds.

The disclosure incorporates the finding that, by means of a securing ring, which is arranged radially inside the receiving body and can be brought into contact with the balancing bodies for the purpose of securing the same, simpler assembly and a secure fastening can be achieved. Since specifically the securing ring can be inserted in such a way inside the receiving body and the balancing bodies arranged in the circumferential direction, the securing ring can exert a retaining force on the balancing body and thus force the latter into the receiving opening against the limiting portion. The fact that the securing ring is, for example, elastically deformable, means that following the positioning of one or more balancing bodies in the receiving body, it can be inserted against the balancing bodies to fix the balancing bodies. Advantageously, the individual balancing bodies do not have to be secured in a complicated manner individually, for example via screw connections. The fact that the securing ring exerts a retaining force on the balancing bodies in one direction, namely in substantially the radial direction pointing outward, and each balancing body is secured in the receiving opening against movements in all other directions, a secure but simultaneously simple-to-assemble balancing device is produced. By means of the securing ring, it is advantageously possible to reduce or dispense completely with the dependence on further form-fitting features which prevent movement of the balancing body in the radial direction, such as dovetail grooves or the like or undercuts that act in the radial direction.

Advantageous developments can be found in the dependent claims and specify in detail advantageous possibilities for realizing the concept explained above within the context of the stated problem and with regard to further advantages.

According to a development of the disclosure, provision is made for the receiving openings each to extend into the receiving body along an opening axis, which is arranged at right angles or obliquely relative to the axis of rotation. In particular, this means that the opening portion and the limiting portion of a receiving opening are located on an axis which is parable or virtually parallel to the radial direction, for example with a deviation of less than or equal to 30° relative to the radial direction.

In a preferred development, the receiving openings are concave. In particular, the receiving opening has a wall portion which extends from the opening portion as far as the limiting portion. The wall portion preferably has an opening aperture angle between a radial inner side of the receiving body and the wall portion which is less than or equal to 90°, in particular at every point of the receiving opening.

In a development, provision can be made for a body longitudinal axis of the balancing body to be arranged along a circumferential direction. The body longitudinal axis can be arranged at right angles to the opening axis and define a main direction of extent of the balancing body. If the receiving body is designed in such a way that the balancing bodies are arranged along the circumferential direction of the rotor, a balancing device with a low axial installation space can advantageously be provided.

In a development of the disclosure, provision can be made for the receiving body and/or the at least one balancing body to have a radially inwardly directed latching groove, which is designed to receive the securing ring. A latching groove which, for example, can have a round or rectangular cross section, permits reliable fixing of the securing ring in that, in particular, it prevents a movement of the securing ring in the axial direction. In that, for example, the latching groove forms a channel that is open to the radially inner side, a securing ring – briefly elastically compressible for the purpose of assembly – can expand into the latching groove after reaching the securing position. Provision can be made for the latching groove to be designed to run around completely in the circumferential direction. In other developments, a latching groove can be distributed in portions at intervals over the circumference. The latching groove can be formed only in the balancing bodies or only in the receiving body or else both in the balancing bodies and the receiving body. The latching groove can be arranged centrally on the balancing body, wherein “centrally” relates in particular to an axial direction, i.e. a direction parallel to the axis of rotation AR. In a development, an external diameter of the securing ring in the unloaded state corresponds to an internal diameter of the latching groove (measured at the base of the latching groove).

According to a development, provision is made for the securing ring to be formed from an elastically deformable material. Suitable materials for this purpose are, for example, Ti6/4, In718, Nimonic 90 or spring steel. Advantageously, the material is chosen such that it has a strength which permits the securing ring provided with a pre-load to be installed and removed again without suffering permanent deformations and/or the pre-load being lost. In particular, the chosen material permits assembly and removal of the securing ring without reaching the region of plastic deformation. In particular, the securing ring is elastic and dimensioned in such a way that a deformation force has to be overcome for the insertion into the latching groove and/or in the assembled state it exerts a retaining force on the balancing body.

According to a development, provision is made for the radial inner side of the receiving body to have a surface treatment, at least in part, in particular in the area of the receiving openings and/or the latching groove, or for the at least one balancing body to have a surface treatment, at least in part, in particular on its upper side. The surface treatment can comprise a coating and/or a modification, in particular an increase, of the surface roughness. The coating can be produced, for example, by means of a CVD or PVD coating or another suitable material application process. The surface treatment can comprise the application of a covering layer. The increase of the surface roughness can be achieved by mechanical production processes, for example material-removing processes with geometrically non-specific or specific cutters, or by using a blasting process with an abrasive blasting medium.. By means of a surface treatment, an increase in the damping can advantageously be achieved, in particular by a layer with different material properties being provided between the receiving body and the at least one balancing weight and/or between the securing ring and the receiving body and/or between the securing ring and the at least one balancing weight.

In a development of the disclosure, provision is made for one or more of the at least one balancing bodies to have a fixing element which is designed to fix the securing ring to the balancing body. In particular, the fixing element is designed to prevent a relative movement between the securing ring and the balancing body in the circumferential direction. In particular, provision can be made for a single one of a plurality of balancing bodies to have the fixing element. The fact that a fixing element is arranged in a discontinuity in the securing ring, and thus fastens the securing ring in the latching groove, means that the remaining balancing bodies can be retained securely in a respective receiving opening in the manner already described via a retaining force exerted by the securing ring. The fixing element can be formed as a separate component and designed to be inserted into a receptacle in the balancing body and connected thereto. In other developments, the fixing element can be designed to be connected integrally to the balancing body.

According to a development, provision is made for the securing ring to have a discontinuity between a first ring end face and a second ring end face. Such a discontinuity can advantageously influence the elasticity of the securing ring, so that assembly is simplified. In particular, as a result the overbearing deformation force which has to be expended to insert the securing ring into the latching groove can be reduced. Via the choice of a suitable material and the dimensioning of the discontinuity, a suitable elasticity can be achieved which, in particular, is still sufficiently high to ensure secure fastening of the balancing bodies.

In a development of the disclosure, provision is made for the fixing element to be designed to be arranged in the discontinuity in the securing ring. The fixing element can thus be arranged in the circumferential direction between the first and second ring end face of the securing ring. In this way, the fixing element can effectively prevent the two spaced-apart ring end faces approaching each other, and thus inadvertent detachment of the securing ring out of the latching groove. Form-fitting fastening of the securing ring in the latching groove is thus achieved. Advantageously, the fixing element and the discontinuity in the securing ring are dimensioned in such a way that in the assembled state the two ring end faces are in contact with the fixing element.

According to a development of the disclosure, provision can be made for the securing ring to have a round or polygonal, in particular rectangular, ring cross section. Advantageously, in developments having a latching groove, the latching groove can have a corresponding cross section in order to permit secure retention of the securing ring in the latching groove.

In a development of the disclosure, provision is made for the balancing body to have a variable radial body height which, along the body longitudinal axis and/or in the circumferential direction, initially rises from a first end face, reaches a maximum radial body height and falls as far as a second end face. In particular, the variable radial body height can correspond to an arcuate form, so that a curved or semicircular or parabolic form of the balancing body results. Such a balancing body has the advantage that it is automatically centered in the receiving body at the latest when the retaining force is applied, or is aligned in accordance with a target position. In this way, the assembly is advantageously further simplified. In addition to such curved height or lateral profiles of the balancing body, other forms of a lateral profile are possible, in particularly multi-angled (polygonal) or, in the simplest case, only one corner at the maximum radial body height, so that, overall, a triangular lateral profile (with a bent upper side and a straight underside) of the balancing body is produced.

In another development, provision can be made for the balancing body to be substantially cuboid and/or to have at least one rounded edge. Advantageously, the receiving opening has a corresponding geometry, for example with appropriately rounded edges.

In a second aspect, the disclosure proposes a rotor for a machine, in particular an engine, for example an internal combustion engine or gas turbine engine or work machine, having a rotor stage with a balancing device according to the first aspect of the disclosure.

In a development of the rotor according to the second aspect, provision is made for the receiving body to be arranged radially underneath an aerofoil platform of the rotor and/or to be connected integrally to the aerofoil platform, in particular for the rotor to be a BLISK rotor. In such rotors, the space-saving and secure balancing device according to the first aspect can be used particularly advantageously.

In a third aspect, the disclosure proposes a machine, in particular an engine, for example an internal combustion engine or gas turbine engine or work machine, having a balancing device according to the first aspect and/or a rotor according to the second aspect of the disclosure.

It should be understood that the balancing device according to the first aspect of the invention, the rotor according to the second aspect of the invention and the machine according to the third aspect of the invention have identical and similar sub-aspects, as are specified in particular in the dependent claims. In this regard, for the development of one aspect of the invention, reference is also made to the developments of the other aspects of the invention.

Embodiments of the disclosure will now be described in the following text with reference to the drawing in comparison with the prior art, which is in part also illustrated. The drawing is not necessarily intended to illustrate the embodiments to scale; rather, the drawing takes a schematic and/or slightly distorted form where useful for explanatory purposes. With regard to additions to the teachings which are directly evident from the drawing, reference is made to the relevant prior art. Here, it should be taken into consideration that a wide variety of modifications and changes relating to the form and detail of an embodiment can be made without departing from the general idea of the disclosure. The features of the disclosure that are disclosed in the description, in the drawing and in the claims may be essential both individually and in any desired combination for the development of the disclosure. In addition, the scope of the disclosure includes all combinations of at least two of the features disclosed in the description, the drawing and/or the claims. The general idea of the disclosure is not limited to the exact form or the detail of the preferred embodiment shown and described in the following text or limited to subject matter which would be restricted by comparison with the subject matter claimed in the claims. Where dimensional ranges are specified, values lying within the stated limits are also intended to be disclosed, and able to be used and claimed as desired, as limit values.

Further advantages, features and details of the disclosure will become apparent from the following description of the preferred embodiments and with reference to the drawing, in which:

### BRIEF DESCRIPTION OF THE DRAWINGS

FIG. 1 shows a first embodiment of a balancing device,

FIG. 2 shows a second embodiment of a balancing device,

FIG. 3 shows a further view of the first embodiment of the balancing device,

FIG. 4A shows a further view of the first embodiment of the balancing device,

FIG. 4B shows a third embodiment of a balancing device,

FIG. 5 shows a perspective view of a balancing body,

FIGS. 6A, 6B show views of a second variant of a balancing body,

FIGS. 7A, 7B show views of a third variant of a balancing body,

FIG. 8 schematically shows, in a sectional illustration, a gas turbine engine,

FIGS. 9A, 9B show sectional views of a high-pressure compressor with a balancing device.

### DETAILED DESCRIPTION

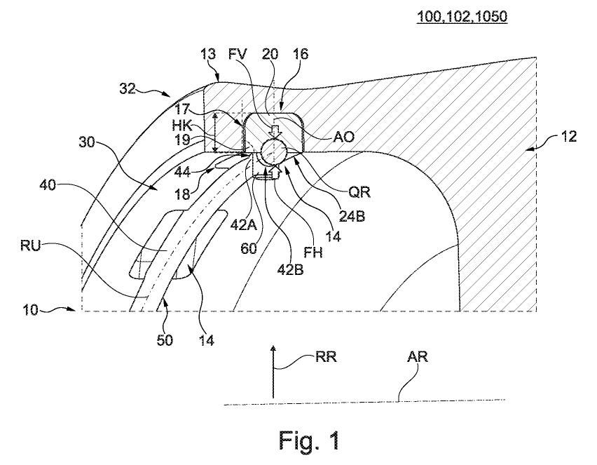

FIG. 1 shows a first embodiment of a balancing device 10 according to the concept of the disclosure. The balancing device 10 is part of a rotor stage 1050 of a rotor 100, wherein the rotor 100 in the present case is designed as a BLISK rotor 102, i.e. as a rotor 100 with integrally molded rotor blades (not shown in FIG. 1). The rotor 100 is mounted such that it can rotate about an axis of rotation AR which, here, is illustrated merely schematically and not to scale. A perspective sectional illustration through a receiving body 12 is shown here, the section likewise extending through a balancing body 20 inserted into a receiving opening 14. The receiving body 12 comprises a flanged portion 13 extending in the axial direction which, in its circumferential radially inner side 30, forms a virtually hollow- cylindrical internal space. On the radially inner side 30 of the flanged portion 13 or receiving body 12 there is thus formed a space via which all the receiving openings 14 of the balancing device 10 are accessible. A number of receiving openings 14 are arranged on the inner side of the receiving body 12, uniformly distributed over the circumference, i.e. in a circumferential direction RU. The receiving opening 14 has an opening portion 18 which is located on the radially inner side of the flanged portion 13. From the opening portion 18, the receiving opening 14 extends outward along an opening axis AO in the radial direction RR over a wall portion 19 is far as a limiting portion 16, which limits a further movement of the balancing body 20 toward the outside, i.e. toward a radially outer side 32. An opening aperture angle 19 between the wall portion 19 and the surface of the receiving body 12 that faces the radial inner side is about 90° in the section plane shown. At the ends at the end faces in the circumferential direction RU, not visible in the sectional view, the opening aperture angle is correspondingly smaller because of the curved upper side of the balancing body 20, for example in a range from 10° to 45°, in particular a range from 20° to 30°. In the present case, the limiting portion 16 is formed as a continuously closed surface. However, in other embodiments, provision can be made for the limiting portion to have openings or holes, for example for weight reasons, or merely to be formed as a step. Here, different shapes are possible as long as the function of limiting the movement of the balancing body 20 in the radial direction RR toward the outside is fulfilled.

The section of the sectional illustration extends approximately over half of the balancing body 20, so that a radial body height HK is located virtually at its maximum. A securing ring 40 in the assembled state of the balancing device 10 shown is located in a latching groove 50 which is formed in the manner of a channel running around in the circumferential direction RU on the radial inner side 30 of the receiving body 12. The securing ring 40 is interrupted in the circumferential direction RU and accordingly has a discontinuity 44 between a first ring end face 42A and a second ring end face 42B. In the inserted state, the securing ring 40 exerts a retaining force FH on the inserted balancing bodies 20. For the assembly or removal, the securing ring 40 can be deformed or compressed counter to a deformation force FV, in order thus to be able to be inserted into the latching groove 50 or removed from the latter. In the present case, a ring cross section QR of the securing ring 40 is circular. Accordingly, the latching groove 50 has a semicircular cross section corresponding to the ring cross section QR. In addition, on its underside 24B, i.e. the side facing the axis of rotation AR, the balancing body 20 is formed with the latching groove 50 which, in the inserted state of the balancing body 20, forms an extension of the latching groove 50 molded into the receiving body 12. Also illustrated in FIG. 1 is a fixing element 60 which, in the present case, is fixed to the balancing body 20 and, in the assembled state, is arranged in a discontinuity 42 in the securing ring 40. Following the insertion of the balancing body 20, the fixing element 60 thus ensures reliable fixing of the securing ring 40, in that in particular it prevents elastic deformation and/or slipping of the securing ring 40 in the circumferential direction RU. Independently of the fixing element 60, further balancing bodies 20, in particular without such a fixing element 60, can be inserted into the balancing device 10 or the balancing body 12.

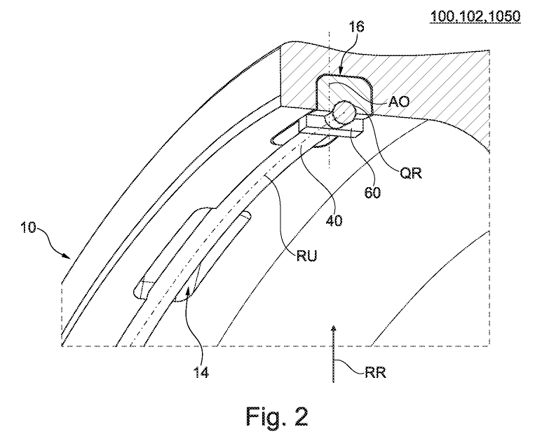

FIG. 2 shows a further, second embodiment of a balancing device 10. As distinct from the first embodiment shown in FIG. 1, the fixing element 60 in the present case has a cuboid shape, as opposed to the cylindrical shape shown in FIG. 1.

FIG. 3 shows a further view of the first embodiment of the balancing device 10 shown in FIG. 1. In the perspective view, an inserted balancing body 20 is again visible, wherein a course of a radial body height HK from a first end face 22A to a second end face 22B of the balancing body 20 is illustrated schematically. It can be seen how the radial body height HK, starting from the first end face 22A, rises in the form of a curve as far as the center, where it reaches a maximum radial body height HKM and then, in the second half of the body length, symmetrically relative to the first half, falls as far as the second end face 22B. In this way, a curved or parabolic or compressed semicircular geometry of the balancing body 20 (and accordingly also of the receiving opening 14) results.

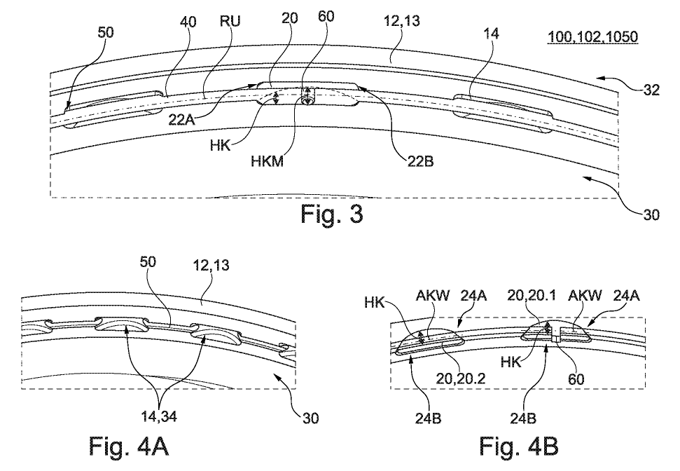

FIG. 4A shows a further view of the embodiment shown in FIG. 3 but without the balancing body 20 and securing ring 40, so that only the receiving body 12, specifically the radially inner side 30 of the flanged portion 13, is shown. The receiving openings 14 are visible here, as is the latching groove 50 extending in the circumferential direction RU and running through receiving openings 14. In optional embodiments, the receiving body 12 can have a surface treatment 34, for example in the area of the receiving openings 14, as shown here. Alternatively or additionally, in optional embodiments a surface treatment 34 can also be carried out in the latching groove 50 and/or on the securing ring 40.

A detailed sectional view of a further, third embodiment of a balancing device 10 is shown in FIG. 4B, in which both a first balancing body 20.1 with a fixing element 60 and a second balancing body 20.2 without such a fixing element are visible. The section of the sectional view extends in an axial plane through the latching groove 50, so that both the receiving body 12 in the area of the latching groove 50 and the balancing bodies 20.1, 20.2 are illustrated as sectioned in their center. The fact that the two balancing bodies 20.1, 20.2 are illustrated as sectioned means that their height profile of the upper side 24A, in the form of a curve in the circumferential direction RU, is visible. A radial body height HK of the respective balancing body 20, 20.1, 20.2 runs along a body longitudinal axis AKW, initially rising and, after reaching a maximum radial body height HKM in the center of the balancing body 20, then falling.

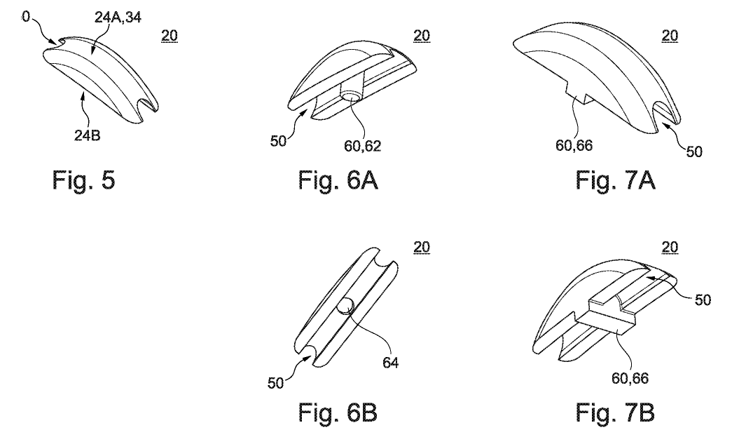

FIG. 5 shows a perspective view of a balancing body 20 which is designed for use in a balancing device according to the concept of the disclosure. An upper side 24A of the balancing body 20 which, in the inserted state of the balancing body 20, is preferably directed outward in the radial direction RR, in the present case has an arched, curved or parabolic surface. An underside 24B of the balancing body 20 opposite the upper side 24A has a flat surface in the present case, which is interrupted only by the latching groove 50. However, within the scope of the disclosure, other geometries in the upper side 24A or the underside 24B are possible. For example, the upper side 24A could have a stepped or polygonal or multi-angled profile. In addition, the underside 24B could, for example, have a form matched to the round course of the receiving body 12 and/or of the flanged portion 13, so that the balancing body is flush with the latter when inserted. In optional embodiments, the balancing body 20 can, for example, have a surface treatment 34 on its upper side 24A, as shown here.

FIGS. 6A and 6B show a further embodiment of a balancing body 20 which, as distinct from the balancing body shown in FIG. 5, has a fixing element 60, in the present case in the form of an insertable cylindrical fixing pin 62. However, other cross sections of a fixing pin 62 are possible, for example polygonal, in particular rectangular, cross sections. In FIG. 6B the balancing body is illustrated without the inserted fixing element 60, so that a receptacle 64 is shown which is designed to receive the fixing element 60, for example with a frictional and/or force fit and/or via a press fit. One advantage of such a balancing body 20 with insertable fixing element 60 is that, in principle, the same type of balancing body 20 can be used both for the use with a fixing element 60 and for the use without such a fixing element 60 since, in the latter case, no fixing element blocks the space for the securing ring 40.

FIGS. 7A and 7B show a further embodiment of a balancing body 20 with a further form of a fixing element 60 which, in the present case, is in the form of an integrally molded fixing stop 66 (as already shown in FIG. 2).

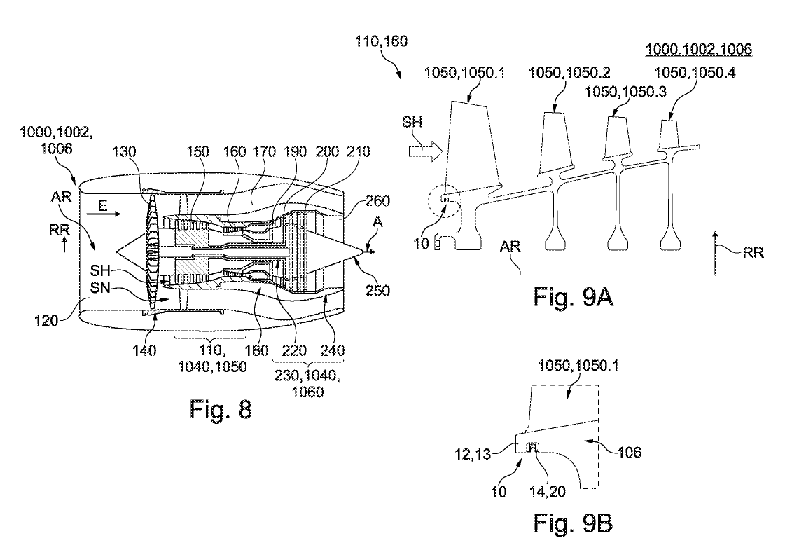

FIG. 8 schematically shows, in a sectional illustration, a gas turbine engine 1000. Engine components are arranged successively along an engine longitudinal axis A of the gas turbine engine 1000, which corresponds in the present case to the axis of rotation AR. At the inlet 120, air is drawn in along an inlet direction E by means of a fan 130. This fan 130 is arranged in a fan housing 140 and is driven by a low-pressure turbine 210 of a turbine 230 via a rotor shaft 220. The turbine 230 comprises at least one rotor stage 1040 in the form of a turbine stage 1060, and adjoins a compressor 110, which has at least one high-pressure compressor 160 and optionally, as shown here, also a low-pressure compressor 150 and/or a medium-pressure compressor. The compressor 110, or in each case the high-pressure compressor 160 and the low-pressure compressor 150, has at least one rotor stage 1040 in the form of a compressor stage 1050. To generate thrust, the fan 130 supplies the low-pressure compressor 150 and the high-pressure compressor 160 and a bypass duct 170 with air. This results in a main flow SH, which passes through the core of the gas turbine 1000, and a secondary flow SN, which passes through the bypass duct 170. The air compressed in the compressor 150, 160 is mixed with fuel in the combustion chamber 180 and combusted. By way of the generated hot gas, the turbine 230, which may comprise at least one high-pressure turbine 190, optionally, as shown here, a medium-pressure turbine 200 and optionally also a low-pressure turbine 210, is driven. The energy released during the combustion is used by the turbine 230 to drive the compressor 110 and the fan 130, in order then to generate the necessary thrust via the air conveyed in the bypass duct 170. Both the secondary flow SN from the bypass duct 170 and the main flow SH flow out via an outlet 260. In this case, the outlet 260 usually has a thrust nozzle with a centrally arranged outlet cone 250. For noise reduction, a mixer is provided, as part of a mixer group 240, in the region of the outlet. As a result of the particular contour of the mixer, the main flow from the core flow and the secondary flow from the bypass duct 170 of the gas turbine 1000 are deflected and mixed such that the resultant swirls reduce the audible noise level. The proposed solution can also be used in gas turbines of different designs, for example in any desired kind of gas turbine engine, for example in an open-rotor or a turboprop engine or a geared turbofan, or stationary gas turbines or other rotating machines.

FIG. 9A shows a schematic sectional illustration of a detail of a compressor 110 of a gas turbine engine 1006, as shown by way of example in FIG. 8, having a number of rotor stages 1040 designed as compressor stages 1050. In the detail, a first compressor stage 1050.1, a second compressor stage 1050.2, a third compressor stage 1000.3, and a fourth compressor stage 1050.4, each adjacent in the direction of the main flow SH, are shown. The detail shown in the present case is part of a high-pressure compressor 160 of the compressor 110.

FIG. 9B is a further detailed view of the high-pressure compressor 160 shown in FIG. 9A, specifically in the area of the balancing device 10. It can be seen how the balancing device 10 is arranged on an aerofoil platform 106 on the radial inner side of the first compressor stage 1050.1 A receiving body 12 or a flanged portion 13 of the receiving body 12 is integrally formed with the aerofoil platform 106. The sectional illustration runs through one of the receiving openings 14, and a balancing body 20 inserted therein can be seen.

### LIST OF REFERENCE SIGNS PART OF THE DESCRIPTION

10 Balancing device

12 Receiving body

13 Flanged portion

14 Receiving opening

16 Limiting portion

17 Wall portion

18 Opening portion

19 Opening aperture angle

20 Balancing body

20.1, 20.1 First, second balancing body

22A First end face of the balancing body

22B Second end face of the balancing body

24A Upper side of the balancing body

24B Underside of the balancing body

30 Radial inner side, radially inner side of the receiving body

32 Radial outer side, radially outer side of the receiving body

34 Surface treatment

40 Securing ring

42 Ring end face

42A, 42B First, second ring end face

44 Discontinuity

50 Latching groove

60 Fixing element

62 Fixing pin

64 Receptacle, pin receptacle

66 Fixing stop

100 Rotor

102 BLISK rotor

106 Aerofoil platform of the rotor

110 Compressor

120 Inlet

130 Fan

140 Fan housing

150 Low-pressure compressor

160 High-pressure compressor

170 Bypass duct

180 Combustion chamber

190 High-pressure turbine

200 Medium-pressure turbine

210 Low-pressure turbine

220 Rotor shaft

230 Turbine

240 Mixer group

250 Outlet cone

260 Outlet

1000 Machine

1002 Engine

1004 Internal combustion engine

1006 Gas turbine engine

1008 Work machine

1040 Rotor stage

1050 Compressor stage

1060 Turbine stage

AKW Body longitudinal axis, body longitudinal axis of the balancing body

AO Opening axis, opening axis of the receiving opening

AR Axis of rotation

E Inlet direction

FH Retaining force

FV Deformation force

HK Radial body height of the balancing body

HKM Maximum body height, maximum radial body height

QR Ring cross section

RR Radial direction

RU Circumferential direction, tangential direction

SH Main flow

SN Secondary flow

1. A balancing device for a rotor, comprising:
a receiving body that is arranged concentrically with an axis of rotation of the rotor and has a plurality of receiving openings distributed about the axis of rotation,
at least one balancing body, which is designed to be received in one of the receiving openings,
characterized in that
the receiving openings have an opening portion on a radially inner side, via which the balancing body can be inserted, and a limiting portion on a radially outer side, wherein the balancing body bears on the limiting portion when in the inserted state, and
the balancing device has a securing ring, which is arranged radially inside the receiving body and is designed to be brought into contact with the at least one balancing body in order to retain the balancing body in the receiving opening.

2. A balancing device according to claim 1, wherein that the receiving openings each extend into the receiving body along an opening axis which is arranged at right angles or obliquely relative to the axis of rotation.

3. A Balancing device according to claim 1, wherein that the receiving body and/or the at least one balancing body have a radially inwardly directed latching groove, which is designed to receive the securing ring.

4. A balancing device according to claim 1, wherein that one or more of the at least one balancing bodies has a fixing element, which is designed to fix the securing ring to the balancing body.

5. A balancing device according to claim 1, wherein that the securing ring has a discontinuity between a first ring end face and a second ring end face.

6. A balancing device according to claim 4, wherein that the fixing element is designed to be arranged in the discontinuity in the securing ring.

7. A balancing device according to claim 1, wherein that the securing ring has a round or polygonal, in particular rectangular, ring cross section.

8. A balancing device according to claim 1, wherein that the balancing body has a variable radial body height which, along a body longitudinal axis of the balancing body, initially rises from a first end face, reaches a maximum radial body height and falls as far as a second end face.

9. A balancing device according to claim 1, wherein that the balancing body is substantially cuboid and/or has at least one rounded edge.

10. A rotor for a machine, in particular an engine, for example an internal combustion engine or gas turbine engine, or a work machine, having a rotor stage with a balancing device according to claim 1.

11. A rotor according to claim 10, wherein that a balancing body is arranged radially underneath an aerofoil platform of the rotor and/or is integrally connected to the aerofoil platform, in particular in that the rotor is designed as a BLISK rotor.

12. A machine, in particular engine, for example an internal combustion engine or gas turbine engine, or work machine, having a balancing device according to claim 1.
